(19) United States
(12) Patent Application Publication
(10) Pub. No.: US 2002/0116421 A1
(43) Pub. Date: Aug. 22, 2002

(54) Method and system for page-like display, formating and processing of computer generated information on networked computers

(76) Inventors: Harold L. Fox, Salt Lake City, UT (US); David L. Faust, Salt Lake City, UT (US); Shang-Xian Jin, Salt Lake City, UT (US); Norman Jones, Scottsdale, AZ (US); David G. Yurth, Holladay, UT (US)

Correspondence Address: LLOYD W. SADLER OR DANIEL P. McCARTHY, PARSONS BEHLE & LATIMER, 201 SOUTH MAIN STREET, SUITE 1800, Salt Lake City, UT, 84111, US

(21) Appl. No.: 09/785,302

(22) Filed: Feb. 17, 2001

(51) Int. Cl. G06F 17/21

(52) U.S. Cl. 707/526

(57) ABSTRACT

A method and system for displaying information from a digital document in a format that presents a paper page-like appearance, including a full-page display and a side-by-side display. This invention provides a method for converting source documents, such as are common on Web sites on the Internet, into a side-by-side printed page format that maintains hyperlinks, images, sound files, video files, and text, while permitting the user to read the information in the familiar book or magazine style. Moreover, this invention provides a means for turning the pages by providing an animated bit-mapped page, turnable on command of the user

### BACKGROUND OF INVENTION

1. Field of the Invention

This invention relates to the display of information on a computer display. More specifically, this invention relates to the display of information, which formats the information in a printed page-like format.

2. Description of Related Art

A variety of computer display formatting systems are well known in the art. Generally, however, prior computer display formatting either limits the display to what can be shown on a single computer screen or employs a vertical scroll down tool as a means for displaying additional information. Moreover, while some computer displays provide for side-by-side presentation, they typically do not preserve the “look and feel” of a multi-page printed media. In particular, these prior systems do not preserve the three-dimensional spatial indexing of the content of a printed publication. These prior displays and formatting systems do not allow for the rapid “skimming” or “speed reading” of a multi-page document with its typical visual context, including photographs, diagrams and tables readably preserved along with selected headline and header text on even low resolution screen displays.

Unlike the prior systems, this invention is directed specifically to enhance the reader's focus on the information content and to remove or minimize distractions to the reading process (e.g., the invention of this application, unlike all known prior art, eliminates or minimizes the need to controls like a mouse pointer for page turning, which force the reader to stop reading the text to position the mouse pointer on an arrow or scroll bar to move to the next page or to position the text for reading. The approach of this invention is analogous to the use of the universal calculator keypad layout or the QWERTY keyboard that allows people to enter data without having to be distracted to see the numbers or letters on the keyboard.

The reader is referred to the following U.S. patent documents for general background material. Each of these patents is hereby incorporated by reference in its entirety for the material contained therein.

U.S. Pat. No. 4,517,598 describes an apparatus and method for formatting and displaying video information having a particular application to electronic publishing systems.

U.S. Pat. No. 4,677,571 describes an electronic printing system for operating both a linear-raster electro-optical display device and a linear-raster type printer, which system is capable of integrating alphanumeric and/or graphics information and gray-scale or picture information, all on a single data base from which one may either (or both) print the data out on the printer as images, or display the data on the display device as images.

U.S. Pat. No. 4,754,326 describes an information retrieval system that includes a help feature, wherein a help key on a terminal can be actuated and a host computer responds by determining the identity of a page of basic information being transmitted at the time the help key is operated.

U.S. Pat. No. 4,768,144 describes an information retrieval system such as a videotext or teletext system in which data is stored in conventional tree format, and the user has the usual capability to move vertically through the tree structure, but also has a novel capability to browse horizontally there through.

U.S. Pat. No. 5,208,903 describes a video image display for predicting color hardcopy image quality, namely the density, color balance, and contrast of an image to be printed on a hardcopy-printing device.

U.S. Pat. No. 5,327,265 describes a process for electronically producing high quality color brochures and other color documents containing color images and related text material using a personal computer for contacting through telephone lines a print center.

U.S. Pat. No. 5,467,441 describes a user-directed method for operating a processor-controlled machine that allows a user to operate on an object-based model data structure from which a first image has been produced in order to apply any of a number of spatially and temporally bounded changes to the first image in a second image displayed in the spatial context of the first image.

U.S. Pat. No. 5,479,603 describes a method for operating a processor-controlled machine to produce a composite view of an original, or first, image by combining the functions of multiple viewing operations and using the model data structure form which the first image was produced.

U.S. Pat. No. 5,485,568 describes a method and device for describing a complex color raster image as a collection of objects in a hierarchical and device independent forms.

U.S. Pat. No. 5,517,578 describes a note taking system that integrates word-processing functionality and computerized drawing functionality for processing ink strokes.

U.S. Pat. No. 5,596,690 describes a method for operating a processor-controlled machine, and a machine having a processor, operate on an object-based model data structure from which a first image has been produced in order to produce a second image for display in the spatial context of the first image.

U.S. Pat. No. 5,649,216 describes a method for automated layout of text elements and artwork on a greeting card.

U.S. Pat. No. 5,652,851 describes a technique for producing a second image for display in the context of an original image that uses a model data structure, in contract to an image-based data structure, and a model-based operation, called a viewing operation.

U.S. Pat. No. 5,675,743 describes a data server for enabling the delivery of data information from any storage device containing said data and an external port requiring the data.

U.S. Pat. No. 5,729,704 describes a user-directed method for operating a processor-controlled machine that permits a user to operate on an object-based model data structure from which a first image has been produced in order to produce a second image for display in the spatial context of the first image, and then to interact with objects in the displayed second image.

U.S. Pat. No. 5,740,425 describes a data structure and method for creating, maintaining, and publishing multiple renditions of both electronic and printed, single and multi-manufacturer catalogs using a single product database.

U.S. Pat. No. 5,778,403 describes a method and system for displaying text in a way that is both aesthetically pleasing and faithful to a printed output.

U.S. Pat. No. 5,781,714 describes a computer system that includes a requesting computer, which asks a responding computer, such as an Internet server, for one or more portions of text.

U.S. Pat. No. 5,793,966 describes a client/server system for authoring an on-line service that uses a server machine accessing a client machine, which performs authoring operations on information stored on the server machine comprising the online service.

U.S. Pat. No. 5,812,776 describes a method for providing access to network servers. In particular, the process described in the invention includes client-server sessions over the Internet involving hypertext files.

U.S. Pat. No. 5,818,455 describes a method of operating a processor control machine, and a machine having a processor for producing human perception output related to an image display feature presented in an original image using the model data structure from which the original image was produced.

U.S. Pat. No. 5,819,092 describes a visual editing system for creating commercial online computer services.

U.S. Pat. No. 5,860,073 describes an electronic publishing system that uses style sheets.

U.S. Pat. No. 5,878,421 describes an information map, which is controlled, on a page call, wherein the information map interface provides access to the structure of both the title and the content within the title.

U.S. Pat. No. 5,890,170 describes a method, apparatus and system for allowing a user to create and add information to his World Wide Web home page, or a private home page.

U.S. Pat. No. 5,890,171 describes a method for rewriting document references such as URLs located in an included document, when an include operation is performed.

U.S. Pat. No. 5,892,509 describes an image processing apparatus coupling at least two image processing system connected to a network.

U.S. Pat. No. 5,893,127 describes an automatic generator of hypertext markup language (HTML) files based on bitmap image data, which faithfully preserves layout information of an original document from which the bitmap data was obtained.

U.S. Pat. No. 5,940,846 describes a method of displaying of an electronic manual, which minimizes the labor and time required for displaying a sentence containing a specific character string, particularly when the character string exists in more than one sentence in the electronic manual.

U.S. Pat. No. 5,950,214 describes a system, method, and computer program for synchronizing, displaying, and manipulating text and image documents in electronic form for display.

U.S. Pat. No. 5,970,231 describes a portable electronic newspaper which is portable, lightweight, battery operated and has a full color display screen, passive stylus for writing and selecting icons from menus, speech and sound reproduction, and the ability to store massive amounts of data.

U.S. Pat. No. 5,991,780 describes a system, method, and computer program product for displaying a patent document and a patent image.

U.S. Pat. No. 5,996,007 describes a method for providing selected content such as product information and announcements during the waiting time of an Internet session.

U.S. Pat. No. 6,003,046 describes a system for retrieving a selected page of a structured document and for automatically developing context information about the selected page.

U.S. Pat. No. 6,012,071 describes a design and layout tool, which defines regions within an electronic publication and provides instructions to a viewer for obtaining and formatting information to be displayed by the viewer within each region.

U.S. Pat. No. 6,018,749 describes a system, method and computer program for generating a new document from a source text document and a source image document.

U.S. Pat. No. 6,055,522 describes a page builder software program that operates in connection with a dynamic content publishing program such as FutureTense Designer.

U.S. Pat. No. 6,072,476 describes an apparatus and method for displaying images that includes a main body having a display unit with a first display screen A and a display unit with a second display screen B and a link for merging the two display screens into one.

U.S. Pat. No. 6,092,091 describes a device and method for filtering information, the device comprising a document database storing document data to be filtered, a reproduced document information storing unit storing fundamental document data used for detection of documents, newly created or updated, a detecting unit for detecting a document, newly created or updated.

U.S. Pat. No. 6,097,887 describes a software system and method is disclosed for creating analytical graphics such as bar charts and the like in an object-oriented Window environment.

U.S. Pat. No. 6,112,181 describes systems and methods for rights management information used at least in part in a matching, narrowcasting, classifying and/or selecting process.

U.S. Pat. No. 6,122,403 describes a computer system linked by using information in data objects employed to provide improvements to steganographic systems.

### SUMMARY OF INVENTION

It is desirable to provide a system and method for providing a “printed pagelike” presentation of information on a computer display. It is particularly desirable to provide a system and method for presenting information on a computer device in a side-by-side manner that is well known to users and which avoids the less effective, inefficient, and often unfamiliar method of “scrolling down” and requiring a user to jump from frame-to-frame through the information, which tend to break the reader's concentration by requiring the reader to manipulate page selection with a mouse-selected page control icon on a display screen.

One of the most common complaints of computer users is that previous ways of displaying pages of information, particularly Internet, CD and LAN provided pages of data, on the computer display is cumbersome, uncomfortable and essentially foreign. What these criticisms reflect is the extent to which Web pages fail to display information in a way that is compatible with the way people are taught to read or scan information on the printed page. Western educated people are accustomed to reading printed materials by scanning with their eyes from the upper left hand corner of the page to the lower right hand corner of the adjoining page. Typically, when we are taught to read our minds are imprinted with this pattern recognition and perception strategy. Western languages work in a left-to-right top-to-bottom form. Images also are often processed by viewers with this technique. The previous methods of electronically displaying information, particularly Internet-acquired information, that of one or more “pages” which are scrollable from top to bottom to present new information to the computer display.

This invention in its present preferred embodiment is specifically adapted to function with information acquired from the Internet or other electronic sources, including but not necessarily limited to computer networks, electronic memory, CD devices, and magnetic memory for display in a Western language. Alternative contemplated embodiments operate without Internet information using information stored on the computer system and can easily be adapted to operate in a manner compatible with Asian language processing.

This invention in its present preferred embodiment operates as a combination of ISP server-based HTML, XML or compressed image file formats, unique page position assignment routines and a memory-resident “plug-in.” When an ISP provides information or other networked data, the information provided in IP mode is downloaded into the operating system of the target computer device. The process of this invention is executed in the target computer to position the received information on the “pages” of a template. When the template containing the downloaded information is operational in the target computer, an image is presented on the target computer display. The displayed image is presented in a format, which is similar to the two-dimensional representation of a common printed book, magazine, catalog or other such printed material. Information allocated to the “pages” of the template is accessed when the user employs integrated tools, the “plug-in,” to turn the “pages” from right to left, left to right or to access other pages via hyper-links contained in a table of contents or index tables, or identified by tabs shown at the edge or in the margins.

This invention is adapted specifically in order to facilitate the ergonomics of the computer display of information and the selection of such information using common computer devices such as a mouse, track ball, keyboard, touch screen devices and/or voice recognition components and software.

By providing an integration of turnable “pages” and the manipulation of data, images, sound, and text in a familiar left-to-right page format, this invention provides the capability of electronic publication presentation in a more useable, robust and user efficient format.

Accordingly, it is an object of this invention to provide a method and system for the presentation of information on a computer display that provides the information in a familiar left-to-right “printed page-like” format.

Another object of this invention is to provide a method and system for the presentation of computer displayed information that provides an easy-to-use page turning and selection tool set.

A further object of this invention is to provide a method and system for the presentation of computer displayed information that avoids the need to scroll vertically through the displayed information.

A still further object of this invention is to provide a method and system for the presentation of computer displayed information that includes soft-switches to enable the user to select user page turning options, in order to provide the look, feel and physical reference features of a book or magazine.

It is another object of this invention to provide a method and system for the presentation of computer displayed information that is fully interactive with the displayed text, compressed images, compressed video and compressed audio.

A further object of this invention is to provide a method and system for the presentation of computer displayed information that provides a conversion of text written in HTML, or a standard word processing text format, into an XML format with multi-page display formatting features.

A still further object of this invention is to provide a method and system for the presentation of computer displayed information that observes the hard page breaks of print formatted material as well as creates soft page breaks based on intelligent parsing of HTML formats, that may not contain page breaks.

It is a further object of this invention to provide a method and system for the creation of simultaneous windows or “pages” of information presented in a side-by-side page template and where sequential pages, which are normally printed “back-to-back”, are visually indexed and displayed in a form that shows the relationship of the pages as they are turning. This feature is important to providing the reader a “spatial context” of the book or publication information. Moreover, it is an object of this invention to provide a method and system for the electronic display of “pages” of information, which provides photographs, illustrations, and headings in the correct “spatial context.” Another object of this invention is to provide a method and system for the presentation of computer displayed information that provides more than one “virtual publication” to be presented at a time.

It is a still further object of this invention to provide a method and system for the presentation of computer displayed information that preserves Internet links to source documents.

Another object of this invention is to provide a method and system for the presentation of computer displayed information that can operate as either a plug-in to a Web browser or as a resident software program.

An object of this invention is to provide a method and system for the presentation of computer displayed information that provides zoom-in, zoom-out capabilities for a reader/user that does not require the zoom boundaries to be set by a mouse or a pointing device.

A further object of this invention is to provide a method and system for the presentation of computer displayed information that permits the annotating, marking, tagging, blocking, highlighting, copying, cutting, pasting of information, and any associated hyperlinks, page numbers or main document identifiers, as well as enhancing “annotation items” in the text, while maintaining any associated hyperlinks.

It is another object of this invention to provide a method and system for the presentation of computer-displayed information that presents the information in a form that characterizes the three-dimensional aspects of printed documents and preserves these characteristics and spatial relationships in an electronic displayed format, thereby orientating a reader to the electronic display, in a manner similar to that of the reader using an standard printed publication. For the purposes of this disclosure, the three-dimensional aspects of printed documents includes, but is not necessarily limited to a cover, binding, page edges, tabs, page markers, and the like.

A still further object of this invention is to provide a method and system for the presentation of computer-displayed information that permits the use of user selected font types, font sizes and styles.

Another object of this invention is to provide a method and system for preprocessing material for presentation.

A further object of this invention is to provide a method and system for storing, in a compact data base format, high resolution compressed images and text.

A still further object of this invention is to provide a method and system for the presentation and display of computer information, which is compatible with transmission requiring minimum bandwidth.

It is another object of this invention to provide a method and system for the presentation and display of computer information that permits the selection of displayable information “on the fly” with a request from the user.

It is a further object of this invention to provide a method and system for the presentation and display of computer information, which is designed to create page breaks from HTML formatted documents, through an analysis of type font size, the amount of text to be displayed in particular type fonts and any page formatting information, including but not necessarily limited to indents, spaces, and charts images.

Moreover, it is an object of this invention to provide a method and system for the presentation and display of computer information by assembling and, preferably, compressing bit mapped page images in computer memory. For the purposes of this disclosure, the compressed versions of these bit-mapped page images is referred to as super thumbnail page views.

Another object of this invention is to provide a method and system for the presentation and display of computer information in a printed page-like format that can operate as a self-contained software solution for information viewing.

Additional objects, advantages, and other novel features of this invention will be set forth in part in the description that follows and in part will become apparent to those skilled in the art upon examination of the following description, drawings and claims or may be learned with the practice of the invention. The objects and advantages of this invention may be realized and attained by means of the instrumentalities and combinations particularly pointed out in the appended claims. Still other objects of the present invention will be become readily apparent to those skilled in the art from the following description wherein there is shown and described the preferred embodiment of this invention, simply by way of illustration of the modes best suited to carry out this invention. As it will be realized, this invention is capable of other different embodiments, and its several details, and specific steps, are capable of modification in various aspects without departing from the invention. Accordingly, the drawings and descriptions should be regarded as illustrative in nature and not as restrictive.

To achieve the foregoing and other objectives, and in accordance with the purposes of the present invention, a variety of computer functions and routines are executed on a standard, typically networked, computer system. These functions presently include: Load Kernel; Standard File Functions, Standard Edit Functions, View Functions, Insert Functions, a Tool Set, a Help Utility, and a variety of operating functions. These functions are described in more detail in the following detailed description of the invention.

### BRIEF DESCRIPTION OF DRAWINGS

The accompanying drawings incorporated in and forming a part of the specification, illustrate a preferred embodiment of the present invention. Some, although not all, alternative embodiments are described in the following description. In the drawings:

FIG. 1a is a top-level system block diagram of the computerized embodiment of this invention in a computer network.

FIG. 1b is a top-level system block diagram of the preferred computer system of used in this invention.

FIG. 2a is a top-level flow chart of the preferred embodiment of this invention.

FIG. 2b is a view of the preferred processor capabilities, wherein the processor performs an authoring function built around an XML tool set with DTDs or Schema to extract content and format information into a documents file set and wherein the file set is then displayed.

FIG. 2c is a view of a specialized short process that takes HTML and converts it to XML format, plus intelligent page formatting to set page breaks along with font and spacing selections for the XSL of the file, producing an XML page description that is rendered internally as full resolution BMP images for the page display to manage for display, to compress thereby forming a “super thumbnail” for storage and for viewing later.

FIG. 3 is a detailed flow chart of the simple display sequence referred to in FIG. 2B.

FIG. 4a is a detailed flow chart of the “Parsing” section of the preferred steps of this invention.

FIG. 4b is a detailed flow chart of the Page Curl or Turn functions of the preferred embodiment of this invention.

FIG. 5a is a detailed flow chart of the HTML “Conversion” section of the preferred steps of this invention.

FIG. 5b is a detailed flow chart of the Word-Processing or Prepress format “Conversion” section of the preferred steps of this invention.

FIG. 6 is a detailed flow chart of the “Display” section of the preferred steps of this invention.

FIG. 7 is a detailed flow chart of the “Page Curl” section of the preferred steps of this invention.

FIG. 8 is a process flow diagram showing the use of the functions and tools of the preferred embodiment of this invention.

FIG. 9 is a detailed flow chart of the steps of the presently preferred authoring steps of this invention.

FIGS. 10a and 10b are a detailed flow chart of the steps of the presently preferred document display steps of this invention.

Reference will now be made in detail to the present preferred embodiment of the invention, examples of which are illustrated in the accompanying drawings.

### DETAILED DESCRIPTION

This invention formats and displays templates on computer screens which present a single page or a double page in a printed-like presentation of text, images and other content presently available in a computer displayable format, typically, shown as HTML text files and/or compressed images. This invention organizes pages in a set of “virtual page sleeves” each of which holds two back-to-back pages per sleeve in an electronic analogy to vinyl “page protector” sleeves. For the purposes of this disclosure, the term “back-to-back” presentation ordering means an electronic display of pages of information, which provides for the back side display of the displayed page while pages are being turned. In this invention the user is provided with ability to “toggle” the displayed pages, turning them from left-to-right and from right-to-left and is able to go directly to particular information through the use of a computerized index, a table of contents, marginal tabs or “spatial references.” This invention also provides the capability of creating and using “virtual” bookmarks, tags, tabs and “dog eared” pages, in order to mark and cut from a displayed document. In the present preferred embodiment of the invention, the user is able to select by selecting a reduced set of images or icons to create pop-up, full-screen images, selecting specially marked reduced images to activate picture-in-picture, streaming-video, and demonstrable image sequences. A variety of methods of selection permitted in this invention, including but not necessarily limited to: dedicated input device, voice activation device, touch screen, computer mouse, track-ball, and computer keyboard. For the purposes of this disclosure, the term “clicking on” shall be interpreted to mean selecting without regard to the device used to accomplish the selection. The user is also able to enlarge text sections, copy and move document content, while at all times maintaining hyperlinks to the original source material. This invention is designed to be fully compatible with standard electronic publishing methods and devices, including, but not limited to the Internet, local and wide-area networks, intranets and extranets and CD-ROM.

As a system, the present preferred embodiment of this invention incorporates a number of routines and functions. At present most of the computer programming has been accomplished in the C++ programming language, although JAVA and/or other programming languages may be substituted without departing from the concept of this invention. The process of this invention is designed to be platform (computer system) independent. In its preferred embodiment, this invention operates in XML rather than HTML, although it is capable of reading and converting documents transmitted in HTML format. The present embodiment outputs electronic documents in XML format, although alternative formats could employ the concepts of this invention in the future without departing from the teachings of this invention. The following are the key major routines in which this embodiment of the invention is accomplished.

A Download routine provides downloading and processing of information from the Internet. Both catalog and book sized documents are supported with appropriate page sizes, font, format and structural information.

A Display template using preferably a minimum of eight pages is programmed to hold eight bit-mapped images to be manipulated by the Page Turn routine. For the purposes of this disclosure, the Display template is a multiple page, virtually bound, potentially double-sided page view with eight bit-mapped pages. While the present mode of the invention uses eight bit-mapped pages, alternative embodiments may perform the functions of this invention using a different number of bit-mapped pages. In this preferred embodiment, two of the eight pages are dedicated to prior pages, two of the pages are dedicated to the next pages, two pages are dedicated to the present displayed pages, and two pages are used for roving to a new link on user command. These eight pages permit rapid formatting and display of desired information upon command of the user.

The Page Turn routine displays a document cover at first, then turns the pages under control of the user, typically by using either keyboard arrow keys and/or mouse clicks on arrow icons, although as noted above other selection devices may be substituted without departing from the concept of this invention. It is also envisioned that a user may “park” a mouse pointing device and use its buttons for left and right page turning selection. As a page is turned, the uncovered page is gradually displayed to reveal the spatial relationship of the previous page's content with the new pates content, and reveals the next backside of the page being turned and the turning process gradually covers the opposite page. A multi-page Display template, using Page Turn is also provided with a single page incremental zoom feature that permits a user to zoom in on the displayed pages. This zoom feature provides the capability of reading fonts as small as 6 and 8 point on medium resolution displays and can be used to facilitate reading by handicapped individuals who must have large font representation.

A Contents routine provides the capability for a user to select, typically by clicking a content line and be provided with a display of the selected page. Alternatively, the user may select a particular page by entering the desired page number on the computer keyboard.

An Index Selection routine is provided to allow the user to display the first page of the index, or by entering the page number of the index to display the desired page of the index. It is also possible to go to a particular page number by selecting either the page number or an item from the index.

An Index routine enables the user to find the proper index page by typing in a word or phrase. When the word or phrase is recognized Page Turn displays the proper index page and also provides an edge view of the book or document, spatially representing other locations in the book that carry the searched term. Recognized is defined as meaning that the next letter to be entered would not move downward in the indexed list of words or phrases. The user can also access any page by scanning the index and clicking on the indexed item. Moreover, the user can accept any page by clicking on the forward or back page turn arrows, or alternatively keyboard function keys, a special access pad, or voice commands via voice recognition computer hardware and software. Future embodiments of this invention may use “virtual reality gloves” as input devices.

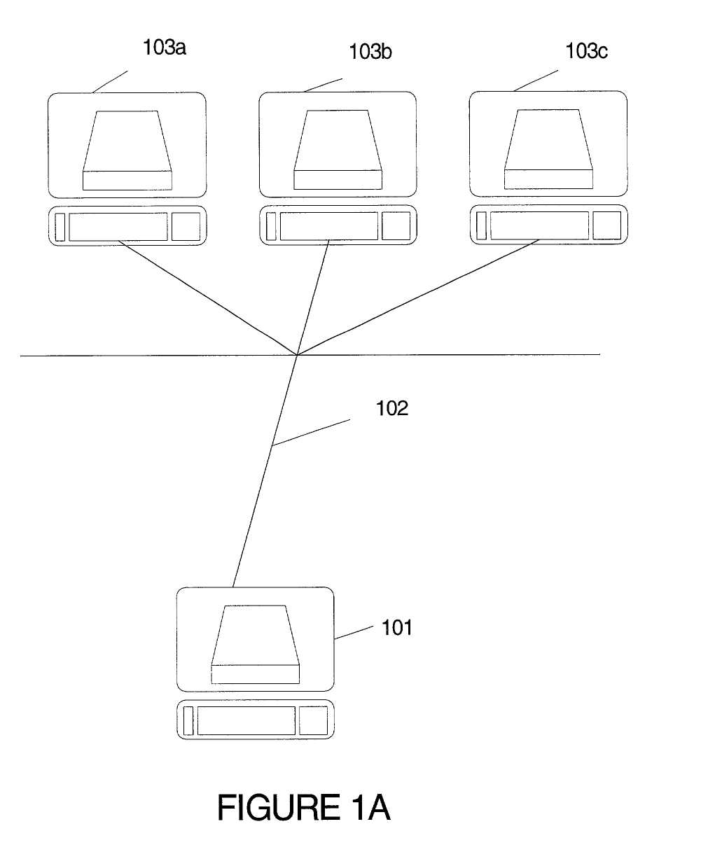

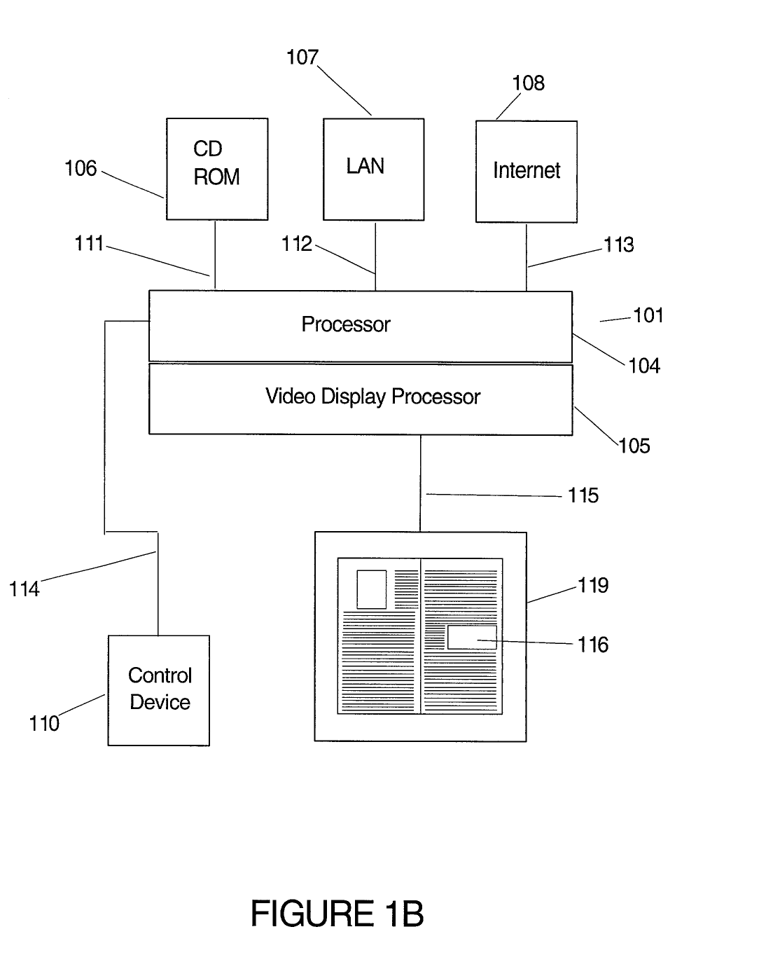

One of the important features of this invention is the process of producing and displaying a page turning representation. The visualization of page turning provides a key visual signal to a reader of a page. This visual signal tells the reader that focused reading is ending and serves to refocus the reader on the broader spatial relationships on of the information on the present and next pages. These visualization signals serve to facilitate speed-reading with high degrees of comprehension, as opposed to the scanning, skimming or browsing process encouraged by prior art computer system “browsers.” FIG. 1 a shows a top-level system block diagram of the computerized embodiment of this invention. In the present preferred embodiment of this invention the method of page formatting and turning is performed on a standard desk top computer system 101 connected by a standard computer network 102 to one or more other computer systems 103a-c. In a preferred embodiment of this invention, communication between computer systems 101, 103a-c are in a Peer-to-Peer medium. Alternative computer devices, including workstations, mini- and main frame computers, laptop or other portable computers, PDAs (personal data assistants) and the like can be substituted without departing from the concept of this invention. Also, while this invention is adapted to efficiently work with documents acquired over the Internet, the method of this invention can also operate on a stand-alone computer device without any network connection at all. In such a situation, this invention works to format and display information held on local storage devices, including, but not limited to, electronic memory, hard disk devices, tape storage and CD devices. Although a variety of computer devices can be used in the system of this invention, it is necessary that the selected computer device be capable of visually displaying information; having one or more input devices, whether a keyboard, mouse, track ball, touch screen, pen stylus, audio microphone for receiving audio commands, and the like; and being a programmable device, that is, a computer device capable of executing software programs, having a processor and memory circuits.

FIG. 1b shows a top-level system block diagram of the preferred computer system 101 used in this invention. In the present preferred embodiment of this invention, processor 104 is in electronic communication 111 with a CD ROM drive 106 device. The processor 104 is also in electronic communication 112 with a Local-Area-Network 107, as well as in electronic communication 113 with the Internet 108. Electronically connected to the processor 104 is a video display processor 105. The video display processor 105 provides the control and communication signals 115 for the computer display device 109. The computer display device 109 is shown here with a magazine type publication 116 being displayed thereon. A control device 110 is provided to convey control signals 114 to the processor 104. In the present preferred embodiment of the invention, the processor 104 is a state-of-the-art microprocessor. The video display processor 105 is connected to the processor 104 via an AGP Bus. The video display processor 105 is presently provided with 4 to 32 Mbytes of video memory, an amount appropriate display of pages having an adequate resolution for user comprehension. The video display processor 105 is preferably adapted to support multiple display devices simultaneously. The preferred display device 109 is typically a 1024×768 resolution CRT monitor. Although it is envisioned and planned in the future to use a High-Definition standard television format (1900×1080) display, which may be a CRT device, a flat screen display or a virtual display device, such as “3-D” goggles. The preferred control device 110 is a keyboard, computer mouse, track ball, voice recognition hardware, touch screen, and/or custom controller. In the present preferred embodiment, the computers used in this invention run standard operating systems, including but not necessarily limited to Windows, Linux, Unix, Apple and the like.

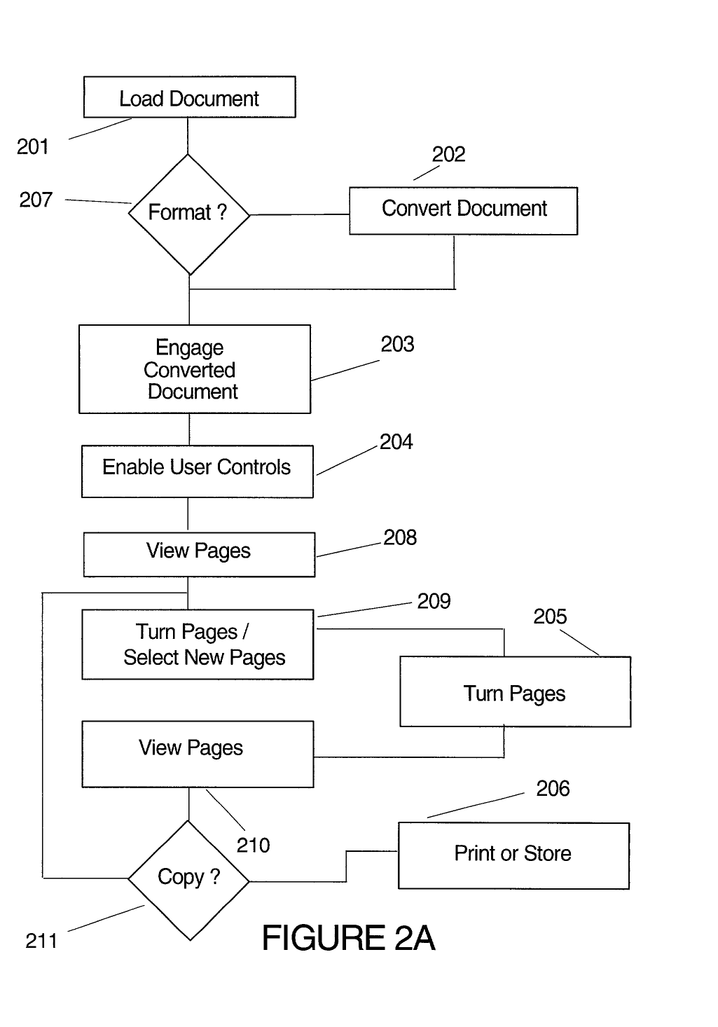

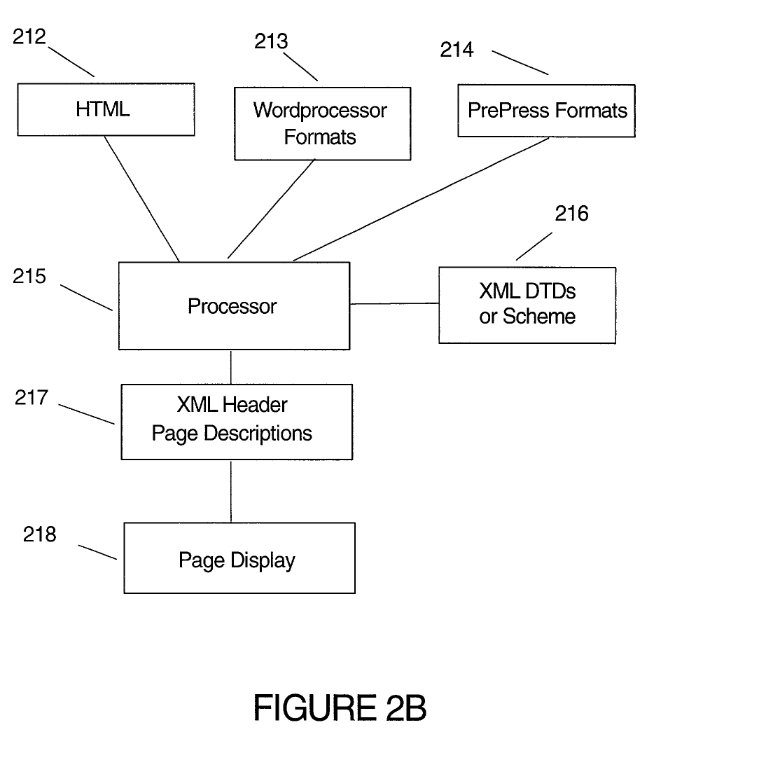

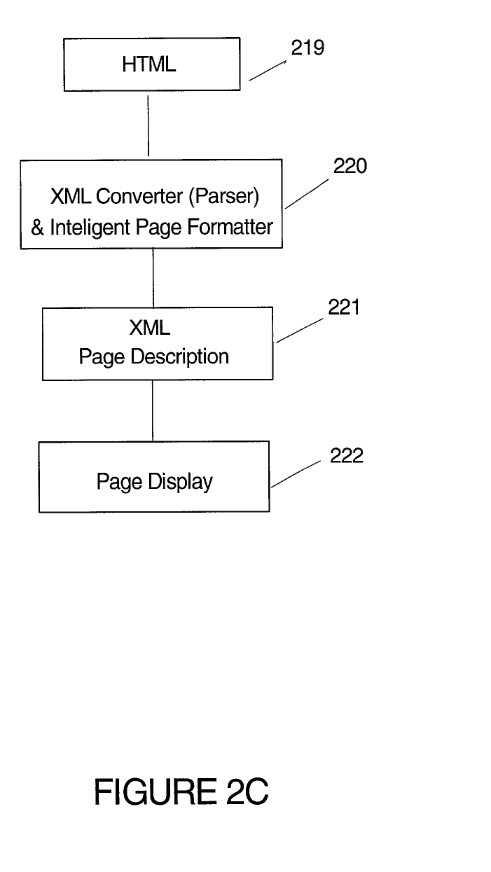

FIG. 2a shows a top-level flow chart of the preferred embodiment of this invention. Initially, a document is loaded 201 from a document source. The present preferred document source is an Internet Web site, although alternative sources, such as local area networks and dedicated storage devices can also be the source of the document to be formatted and displayed. Essentially, any known computer memory device can serve as a document source. A test 207 is made to determine whether the loaded document requires formatting. Typically an HTML document requires formatting, while a word processor or pre-press formatted document may not require formatting. If the document requires formatting, the received document is converted 202 from a generally vertically scrolling extended format representing several pages of material to a page turning, side-by-side, “virtually bound” display format. This conversion 202 step typically includes a conversion from HTML to XML along with various formatting and pagination modifications. The typical Internet source document has a particular vertical scrolling format. The user is generally presented with a few lines, often as few as ten lines, at a time. As the user reads the document, new information is made available by such methods as scrolling down either by mouse clicks or arrow keys, or by selecting a new page to be loaded, by clicking a “go to” style button, a “next” or “previous” button. After conversion, the information is prepared for either a single page or a side-by-side page display, similar to that of a standard paper book or magazine. This conversion 202 step includes receiving information concerning the display device, such as size, shape, resolution and color capabilities. This information is necessary for the most efficiently displayed form of page-turnable information. This conversion 202 step further includes converting the document from a “static” document to a “dynamic” document. For the purposes of this invention disclosure, “static” should be interpreted to mean that while the user can request additional information, the information in the received document is not capable of interactive modification by the user. While “dynamic” should be interpreted to mean that the displayed document can be altered by the user, using such functions as blocking, cutting, highlighting, inserting, expanding images, and playing sound and/or video clips. Following the conversion 202, the resulting document is engaged 203 for display on the user's computer display device. In its preferred mode of operation, the engagement of the displayable information is presented as a bit-map fixed to a transparent wireframe model. This display form permits the manipulation of the wireframe model. That is, when the user commands the program to turn a page, the page appears to turn in a simulation of a three dimensional page. The page appears to lift at its edge, the edge getting closer to the viewer. Since the document text and images are fixed as a bit-map, they remain locked to the transparent wireframe model, thereby changing in perspective to the viewer as the page is turned. This part of the process is referred to as the turn pages step 205 of this process. User controls are enabled 204 to permit the user to control the rate, direction and turning 205 and/or selection 209 of pages and documents. In the present preferred embodiment of this invention, the user controls 204 include programmed “Next” and “Previous” buttons, arrow keys, and numeric input for direct page selection. Upon command of the user, pages are viewed 208. The user may then turn the pages or otherwise select new pages 209. The displayed pages are turned 205 as described above and the new pages are then viewed 210. If desired, 211, the information may also be copied 206 from the displayed pages to a file in the user's computer or printed on a computer printer device. In the preferred embodiment of this invention, this copying is performed in a manner such as to maintain formatting and Web sites links, if any. Also, in this preferred embodiment of the invention, the XML content and document identification tags are included with the page-specific copy function to allow the storage of the copied items with the knowledge of the source document preserved and available.

FIG. 2b shows a view of the preferred processor capabilities. In this invention the processor 104 performs the authoring function, based on an XML tool set with the Document Type Descriptors (DTDs) or schema to extract content and format information into a document file set and then processes for the page display of the electronic form of the document. Source documents of an HTML 212 format, Word processor 213 format, and Pre-Press 214 formats are provided to the processor function 215. Among other functions, for HTML 212 documents, the processor function 215 calculates page breaks based on page length, font and figures on the page. The processor function 215 receives XML DTDs or schema 216 for use in the processing of the received document. The processor function 215 generates an XML Header and page description 217. The preferred page description includes page context, format and links, which in the preferred embodiment of the invention are provided in a full feature data base form. This XML header and page description 217 is provided to the page display function 218 via the video display processor 105 to the computer display device 109.

FIG. 2c shows a view of the specialized short process that takes HTML and converts it to XML format, including intelligent page formatting to set page breaks along with font and spacing selections for the XSL of the file, then producing an XML page description that is rendered internally as a full resolution BMP image for the page display to manage. The HTML formatted document is received 219. The received HTML formatted document is processed by the XML Converter (Parser) and Intelligent Page Formatter 220. An XML page description is produced 221. The XML page description is passed to the page display function 222.

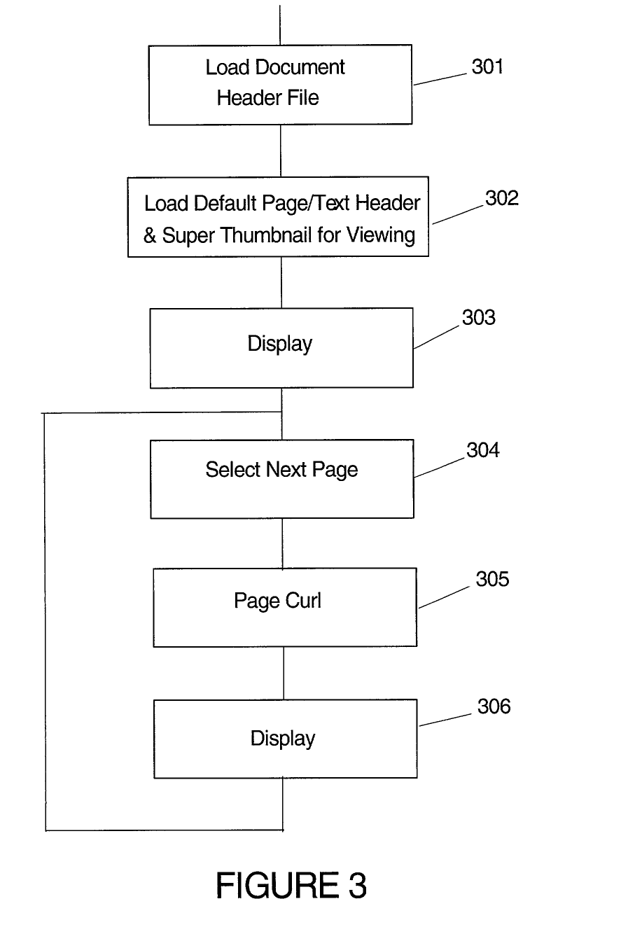

FIG. 3 shows a detailed flow chart of the “Loading” section of the preferred steps of this invention, wherein the process of writing to the display is described. The document header file is loaded 301. This document header file is preferably received in the full database format and contains information describing the desired doublewide page display format. The default page/text header and super thumbnail is loaded 302 for viewing. This step 302 tells the process what pages are being loaded. A super thumbnail is a compressed image of a page that maintains the readability/comprehension of the displayed information. Also, in the preferred embodiment, a super thumbnail maintains the spatial relationships of the various information. The page information is then loaded into graphic memory for display 303. In the present preferred embodiment eight panes or displayable pages of information are stored in this step 303. The user may then select 304 a next page. This selection 304 may be made by selecting right, left, zoom, jump or new document selection. Once a new page is selected 304, the page display is curled 305. The curling 305 of a page, in the preferred embodiment, maintains the readability of the page as long as possible while turning and slides or curls the new page into view. The resulting pages are then displayed 306, by writing the desired information into display memory on the video display processor 105. The page curling process 305 is then repeated as requested by the user.

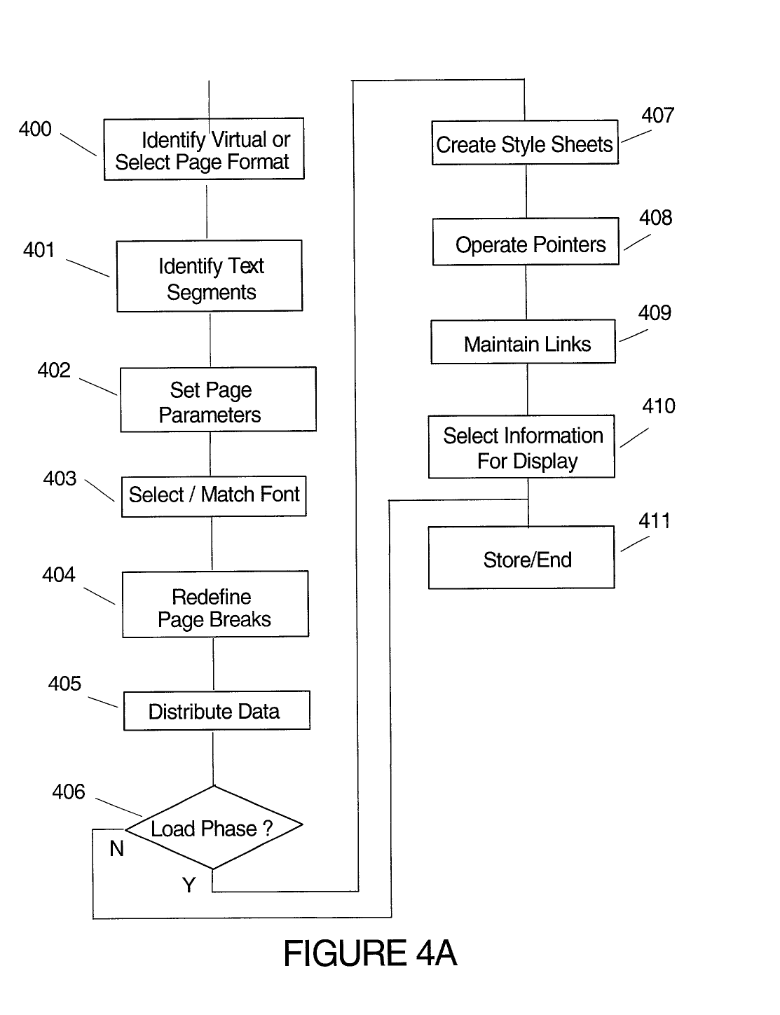

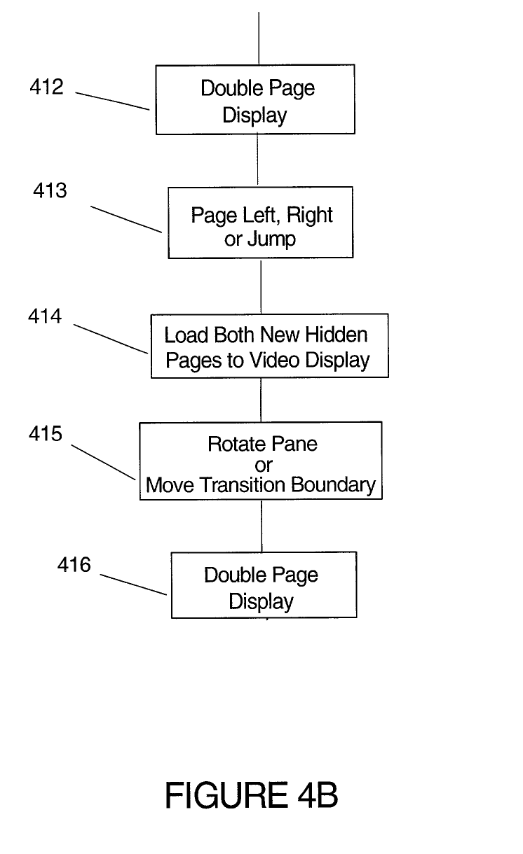

FIG. 4a shows a detailed flow chart of the “Parsing” section 220 of the preferred steps of this invention. Parsing is the process of going through the document to identify particular document elements and identifying formatting for subsequent page view. Initially, virtual or selected page formats are identified 400. Text Segments within the document are identified 401. Identification of test segments includes the formatting of the structure of the document, including type fonts and page breaks if any. Page Parameters, including but not necessarily limited to margin and tab settings, are set 402 for page view. The font or fonts are selected or matched as necessary 403 to display a print font that may, in some instances, be compromised for the display device 109. Page Breaks are created 404, by the input parser to be appropriate for page view. The parser may create page breaks where none previously exist, such as is typical with HTML format documents. Typically, the appropriate page view Page Parameters are determined based on the computer screen parameters received in step 203 above. Data, that is text, image and sound components of the document, are distributed 405 to a viewer window. A test 406 is made to determine if the parser is being used in the Load Document 201 phase. If not, the parser section is completed 411. If the parser is being used in the Load Document 201 phase, Style Sheets, in the case of XML format, which are XLS, files, are created 407 for each set of pages. The Style Sheet for a page includes the desired data from the document placed in the page view format. User pointers are enabled to operate 408 the user selection of a desired page. Internet links in the original document, if any, are maintained 409 by placing the necessary hypertext link in each page view formatted page. A selection 410 is made of the information, which is stored in a display file.

FIG. 4b shows a flow chart of the preferred page curl or turn process. It is desirable that proper resolution BMP page images are loaded into video memory in advance of the page movement. The simplest movement is a pane rotation with a “swinging door” effect, while the more desirable and appealing movement is a curling of the true top edge to lower left edge that effectively moves an image boundary between the front of the moving page and its back side, thereby revealing the image on the back page gradually until the back side of the front page is fully viewable and the front page is fully obscured, at which point the back page is considered a new front page. Alternatively, the curling can be done from the true bottom edge to the top right edge. The curling can be, in the preferred embodiment, accomplished along a wide variety of angles. A double-page display is initialized 412. In alternative embodiments, a single page display can be substituted. Upon user selection the page curl or turn selection is made 413. This selection 413 can be to the left, right or a jump to an entirely new page. The new hidden pages are loaded 414 to display memory. These new hidden pages are typically the pages consecutively located either before or after the desired displayed pages, but which are displayed only upon subsequent curling or turning. A transition pane or transition boundary is rotated or moved 415. Rotating a pane is typically done about the center edge, while moving the transition boundary is typically done from an edge or corner. The new double page is then displayed 416 by reading the displayable information from display memory to a computer display device 109.

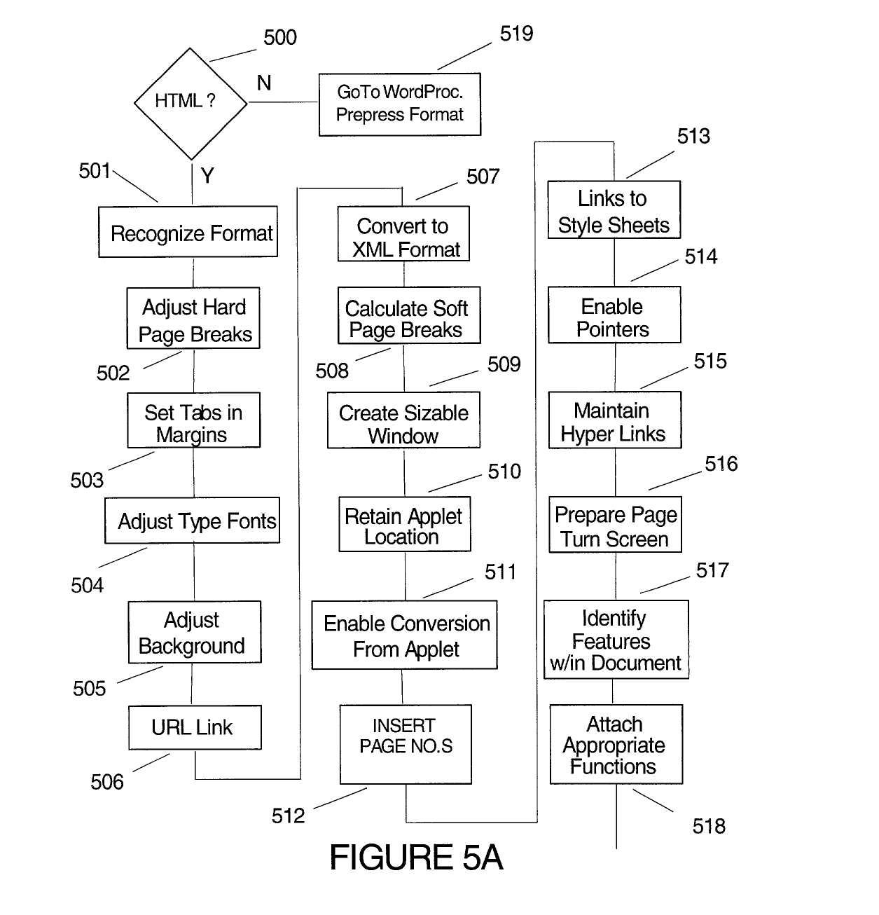

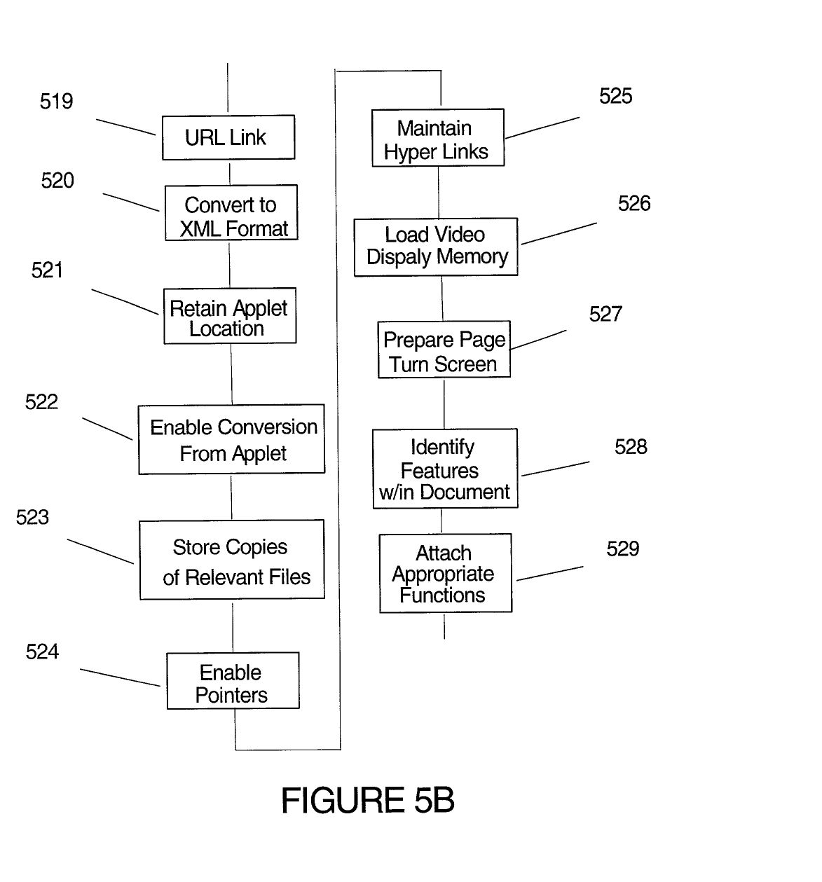

FIG. 5a shows a detailed flow chart of the “Conversion” section 202 of the preferred steps of this invention. First, a test 500 is made to determine if the source document is received 301 in an HTML format. If the source document is not received in an HTML format, the process goes to the Word Processing or Pre-Press format processing 519. If it is an HTML formatted document, initially the HTML format is recognized 501 thereby identifying the preferred page size. Hard page breaks are adjusted 502. Tabs are set 503 are set in the margins. Type fonts are adjusted 504.

The background information, including colors and patterns in the background of the source document, are adjusted 505. URL, Web site addresses, are linked 506.

Conversion 507 to an XML format is next performed. Soft page breaks are calculated 508. Sizable Window viewers are created 509. Applet locations are retained 510 relative to the surrounding elements. A conversion from Applet to a compressed audio/video packet is enabled 511. Page numbers are inserted 512. Links to style sheets are created 513. Pointers are enabled 514 and hyperlinks are maintained 515.

The page turn screen is prepared 516. Features within the document are identified 517 and appropriate functions are attached 518.

FIG. 5b is a detailed flow chart of the Word Processing or Pre-Press format “Conversion” section of the preferred steps of the invention. After determining that the format of the received document is a Word Processing or Pre-Press format 500, a URL link is made 519. The document is converted 520 to XML format. Applet location is retained 521. Conversion from the Applet is enabled 522. Copies of relevant files are stored 523. Pointers are enabled 524. Hyperlinks are maintained 525. Video display memory is loaded 526. The page turn screen is prepared 527. Features within the document are identified 528, and appropriate functions are attached 529.

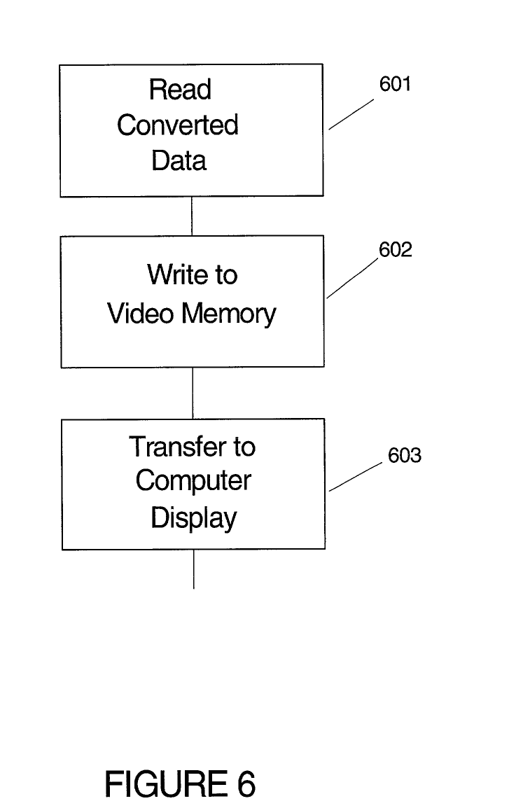

FIG. 6 shows a detailed flow chart of the “Display” section 218 of the preferred steps of this invention. Initially, the converted data is read 601 from memory and written 602 into video memory. The data stored in video memory is transferred 603 to the computer display.

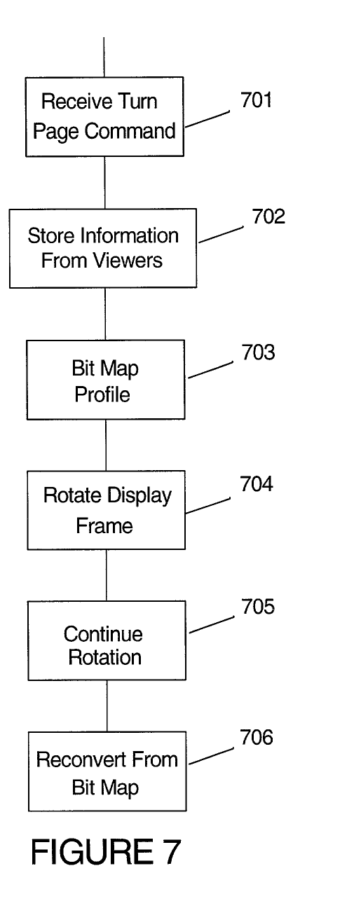

FIG. 7 shows a detailed flow chart of the “Page Curl” section of the preferred steps of this invention. The Page Curl section of this invention provides the mapping and animation of the displayed pages. The following are the present preferred steps of the Page Curl section of this invention, which is executed after the page view information is displayed in the viewer. A turn page command is received 701. Next, information from the page view, typically from the four windows the two presently displayed along with the “next” and the “previous” pages is stored 702 into a bit map.

The bit map profile 703 is converted into a bit-map, adaptable for being fixed and is then fixed to a wireframe for animation. The wireframe having the fixed bit-map of the displayed pages is rotated 704 in the direction selected by the received 701 turn page command. In the preferred rotation 704 of this step, the bit-mapped wire frame pages are curled as they are turned. In alternative embodiments, the rotation 704 can be shown in a manner that presents the turning page essentially flat. The rotation continues 705 until the bit-mapped wire frame page is again displayed a flat on the display device. At this point the bit-mapped wire frame page is reconverted 706 back from a bit-mapped bit map to the page view. In the page view animations, multimedia, images and URLs are maintained for selection, zooming and the like by the user.

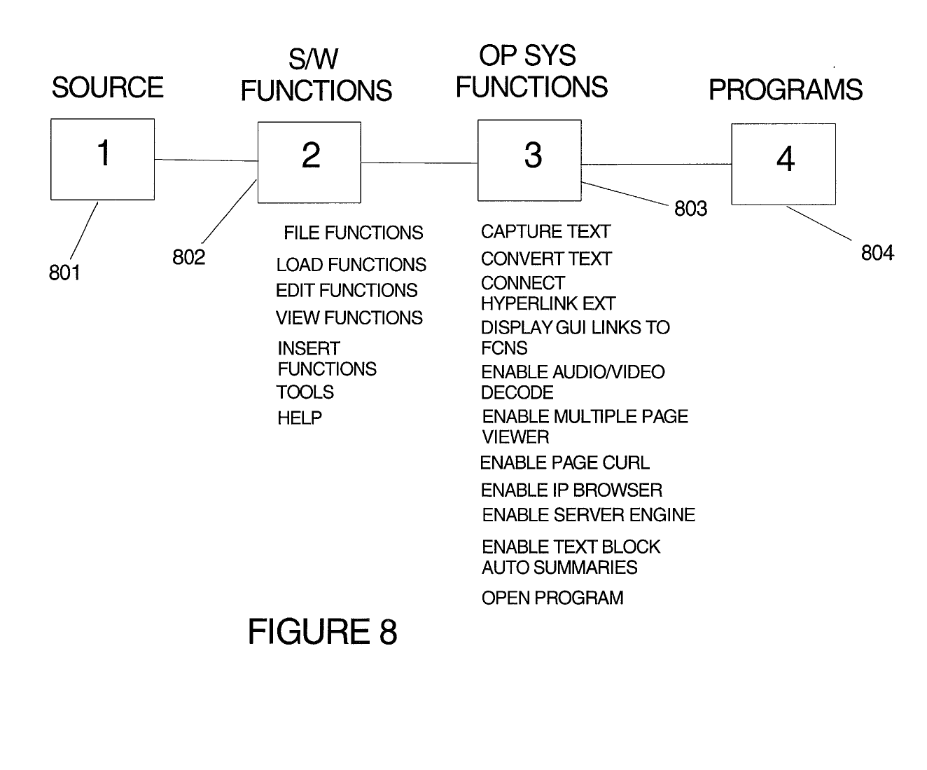

FIG. 8 is a process flow diagram showing the use of the functions and tools of the preferred embodiment of this invention. The source 801 of the document of interest is preferably a file stored on a hard disk drive, a CD-ROM, an Interactive DVD, an Online IP Browser connection and/or a Disk Device file. The document received from this source 801 is operated on by a variety of Software (S/W) Functions 802. In the present preferred embodiment of this invention the following Software Functions 802 are provided:

load kernal functions which includes:

a multiple page display routine;

a text acquisition/accumulator;

a text converter HTML to XML to True Type Fonts;

hyperlink extensions; and

page turn controls key functions/mouse control;

file functions which includes:

select file;

open file;

close file;

save file;

save “As” file;

save to location;

save as Web page with hyperlinks;

print setup;

print file;

send file;

and properties;

edit functions which include:

select/block text;

copy;

cut;

paste/hyperlink;

highlight;

find/orthogonal search;

go to curser location to point from one document location to another without losing the reference point; and

add links;

view functions which include:

normal for a regular page view;

Web layout for a Web page layout;

print layout for a print layout;

toolbars/customization;

document map;

full screen viewer to select minimum or maximum views;

toggles/no toggles to jump direct to predefined locations;

zoom +/− for display zooming functions; and

split screen/multiple documents

insert functions which includes:

comment/interlineate;

footnote/endnote;

cross-reference;

caption;

index links;

compressed video enable/disable;

compressed audio enable/disable;

bookmarks; and

hyperlinks;

tools functions—which includes:

language translator(s);

word count;

autosummarize (text grabber);

look up reference;

orthogonal search;

multiple documents;

merge documents;

online collaboration;

protect/encrypt document;

park mouse with function key toggle; and

online IP browser connect;

help functions which include:

search by topic, using an orthogonal search engine;

index;

contents;

and detect and repair document errors.

Operating System functions 803 operate on the document received from the S/W functions 802. The Operating System functions 803 of the present preferred embodiment of the invention, includes:

capture text/document functions which include functions for capturing documents from the following:

IP link/browser plugin;

CD-ROM;

Interactive DVD; and

HDD/Disk Sources;

convert text from HTML to XML to True Type fonts function;

connect to hyperlink extensions function;

display GUI, with links to functions, including:

back (or previous) page;

left and right page commands;

next page;

view options;

file save options;

index;

table of contents;

chapter/location selector;

go to;

find/search; and

collaborate online; and

enable audio/video decode functions, which includes:

file source/embedded data files;

and online source/streaming video and audio files;

an enable multiple page viewers function;

an enable page curl with text capture and hyperlink extensions functions;

an enable IP/browser function;

enable orthogonal search and data collection functions;

enable text block autosummarize functions;

and an open program function.

Following the operating system functions 803 general-purpose programs 804 operate.

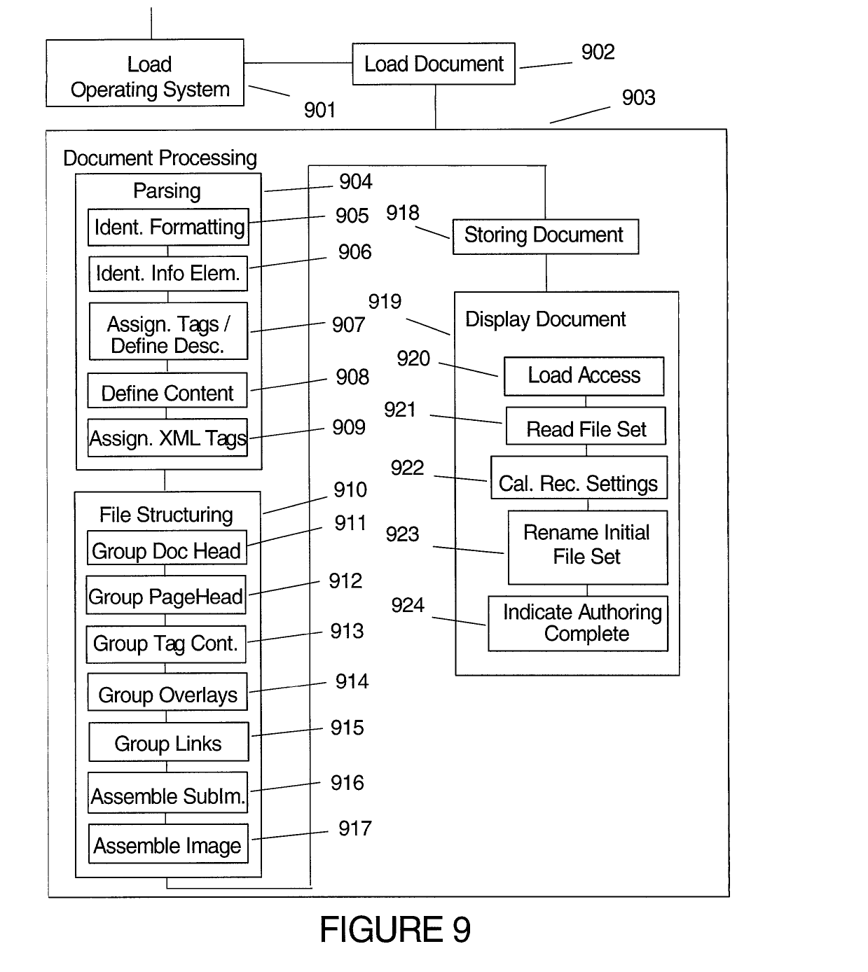

FIG. 9 shows a detailed flow chart of the presently preferred authoring component steps of this invention. Initially, the a stand-alone operating system program is loaded 901. In the present preferred embodiment of this invention, the operating system is Windows 98, although alternative operating systems are compatible with this invention. The document of interest is loaded 902 into the Page Turner program. As previously noted, the document of interest may be in a Word Processor (for example: RTF, Word, WordPerfect and the like), or a document transmission format (for example: Acrobat PDF). Application modules for the Word Processor and/or transmission format may be required for the loading of the desired document. The preferred document includes some or all of the following information: text for document components (including: book cover, book end binding, book hard covers, title page, table of contents, main text in chapter organization, indexes, appendices CD-ROMs, and miscellaneous other materials such as advertisements); font definitions for text segments, typically linked to physical outlines of the fonts to allow the definition of page breaks relative to the physical margins of the pages; images (including: photographs, diagrams, and artwork); formatting and page layout against a specific paper size, including information margins relative to the physical page size; and packaging of the document in order to allow the complete document to be constructed in virtual space, that is, in computer memory. The document is processed 903. This processing step 903 includes parsing 904, structuring 910 files in a document folder, storing 918 the processed document (typically this document may be linked to form a single file but for the purposes of this disclosure is identified as individual files), and displaying 919 the document. The present preferred document file folder includes the following: a document header file; page header files; page text content files; page content and image format pointers to the full-page views; page links, compressed sub-images; compressed pages (the “super thumbnails”) which provide the book format dimensions with the exception of the edge binding that reflects those dimensions; and linked supporting files (such as sound, video clips and auxiliary documents).

The parsing step 904 in the present preferred embodiment includes the following sub-steps. Formatting of text and images (generally bit-mapped) segments is identified 905. Information elements (including: headings, text blocks, images, captions, footers etc.) are identified 906. Using a format and structure identification DTD, XML tags are assigned 907 to structures (such as headings, text blocks and the like), and XLS page layout description is defined and an XLL linking map is created. Based on the detection of page breaks, the content of an individual page file within a document is defined 908. Using content tagging DTD, XML tags are assigned 909 to the content of the identified text strings in the document. Generally, this content-tagged DTD is specific to the content of the publication.

The structure 910 step in the preferred embodiment, further comprises grouping 911 the XML tagged document header layer for all pages; grouping 912 the XML tagged page header layer for each page; grouping 913 the XML tagged content for each page. The content and image format map overlays for the full-page view are grouped 914 to guide the zoom capability and to determine when the super thumbnail is used for display as opposed to the assembly of the full page. The links from the page that directs the focus within the document and the URL links that jump from the document to Audio or video clips that complement the document are grouped 915. All XML-tagged sub-images are assembled 916, holding images initially in the highest available resolution bit map form to be accessed for the assembly 917 of the complete page, then compressing the individual bit maps and then storing the layer.

The present preferred display document step 919 further comprises the sub-steps of loading 920 access to newly assembled file sets. Reading 921 file set “4”, which contains page content and image format pointers and looking for a time creation data tag. The recommended settings for a 1024×768 display are calculated 922 and provided for user directed optimization. The initial file set “4” is renamed to “RAW” and stored to a new file. Indications to the user that the authoring is complete is sent 924 and the program exits.

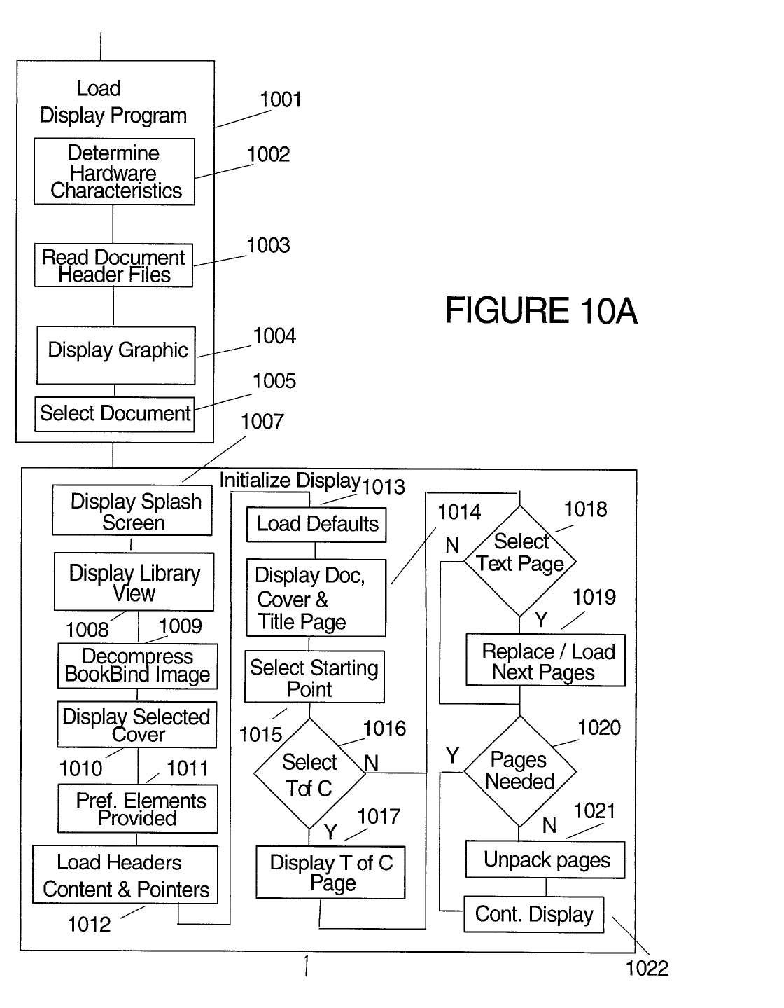

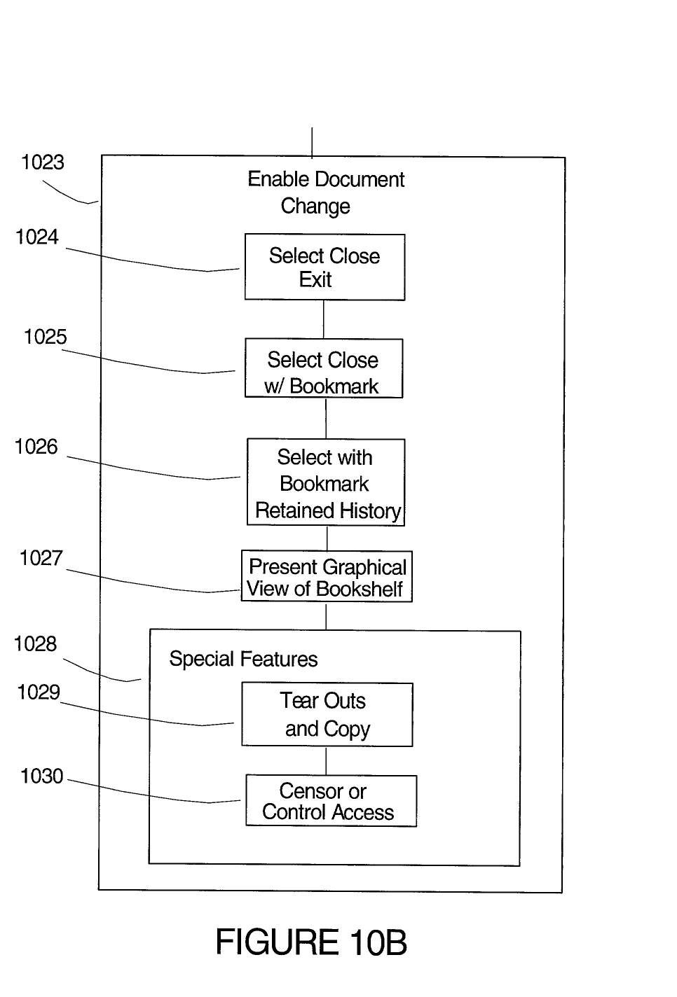

FIGS. 10a and 10b show a detailed flow chart of the presently preferred document display steps of this invention, begun on FIG. 10a and continued on 10b. Initially, the stand-alone executable display program is loaded 1001. Next, the display is initialized 1006. And document change is enabled 1023.

The loading 1001 of the display program further includes the steps of determining 1002 the hardware characteristics of the displaying computer and determining the optimum display and zoom strategy. This determination preferably includes the consideration of the screen resolution, video memory and enhanced graphics capabilities of the display (preferably minimally a resolution of 1024×768, video memory of 4 Mbytes and OpenGL compatibility is desired), the processor speed and memory (preferably a minimum of 350 MHz process and 64 Mbytes of memory), access to stored data (that is the availability of CD-ROM, hard disk and/or LAN), and reserved main and display memory. Next, the program reads 1003 the document header files in each Page Turner document file folder to locate on the DEFAULT storage media. If multiple files exist with more options than can be displayed the program preferably offers the user a choice of groupings to narrow the list to a set whose binders can be displayed. The program then displays 1004 a graphic display of bookend bindings, preferably, in a library shelf format. Books, or other documents, can then be selected by rotating through the book edges. The desired book or other document is selected 1005, bringing up full title and author information with the option of displaying an abstract, if available, along with the table of contents, an index or the first page of the document.

The display initialization 1006 further comprises the steps of displaying 1007 a splash screen, which allows the user to select a control scheme for the program. Displaying 1008 a library view and a book selection screen permitting the user to select a book. This displaying 1008 preferably includes loading and decompressing 1009 bookbinding images for the “library display” then loading and displaying 1010 a selected book cover (typically on the left screen) and the title page (typically on the right screen). The preferred elements of the double page display are provided 1011; including loading 1012 the headers and all page content and image format pointers for the full-page views. The process defaults 1013 to loading and decompressing super thumbnails to 2× of the user's display device resolution. The book, or document, cover and title page are displayed 1014. The user can then select 1015 a starting point location-based action. If 1016 the user selects the Table of Contents, a display program fills in 1017 the remaining Table of Contents pages, preferably in up to 8 viewers. If 1018 the user selects the first text page, the program replaces 1019 the book, or document, cover and loads and unpacks the next three pages in place of the book cover, title page and index. If 1020 pages are not needed in the viewers, all unpacked “super thumbnail” pages are placed 1021 in a temporary document buffer to permit easy re-access within the limitations set by the system's hard disk drive storage and the user's settings. Generally, once accessed the table of contents and the index remain resident in memory. The display continues 1022 from the same book or publication. During this continued display 1022, the user can continuously flip pages (using mouse buttons, keys or a custom paging control device or the like as defined previously), can select the table of contents, the index and/or can visually “cut” to selected regions of pages (using the binding view), can incrementally step through preset options or approximate an entry point into the pages that are proportionally mapped on the binding view. In one preferred embodiment of this invention, a binding view will provide page numbers or chapters as tabs to select in the same manner as user defined or subject tabs.

The enabling a document change step 1023 further comprises, in the present preferred embodiment, selecting 1024 close and exit, selecting 1025 close with a bookmark, selecting 1026 with a retained reading history and bookmarks. This retained reading history and bookmarks option provides a summary of all pages “visited” and will allow the summary to be graphically mapped in terms of time on a page or area of book or publication visited. A typical flipping action will be recorded for less than 1 second. A quick scan may be recorded for 1-5 seconds. Reading fast may be recorded for 5-20 seconds and reading slow may be recorded for 20 seconds or more per page. In a review process, a selection of all pages that were examined for longer than 30 seconds may reveal what part of a publication or document was involved in a search effort, thereby making it relatively easy to relocate. In teaching situations, this feature can provide feedback on the focus of the student. A bookshelf view or tabular view is then graphically presented 1027 to permit a user select another document or publication. In the preferred embodiment of the invention it is possible to log the access and even the time that the selected items have been viewed. It is possible to identify if multiple readers have checked on the same document and, if desired, comments from the readers can be recorded. Special features can be employed 1028. These special features, include but are not necessarily limited to tear-out and copy 1029, which provides for the selection of pages to be copied and sent to a printer or an e-mail address. The capability exists in the preferred embodiment to record instances of copying in order to provide for copyright fee accounting and payment. The capability of censoring or controlling access 1030 is also provided to give password or key control to information, publications or books as may be desired. This feature is of particular desirability in business environment where confidential trade secret information is managed and in a school or library where sensitive or adult information access is desired.

The foregoing description is of a preferred embodiment of the invention and has been presented for the purposes of illustration and description of the best mode of the invention currently known to the inventors. This description is not intended to be exhaustive or to limit the invention to the precise form, connections or choice of the components disclosed. Obvious modifications or variations are possible and foreseeable in light of the above teachings. This embodiment of the invention was chosen and described to provide the best illustration of the principles of the invention and its practical application to thereby enable one of ordinary skill in the art to utilize the invention in various embodiments and with various modifications, as are suited to the particular use contemplated by the inventors. All such modifications and variations are intended to be within scope of the invention as determined by the appended claims when they are interpreted in accordance with the breadth to which they are fairly, legally and equitably entitled.

1. A digital computer system for displaying of computer information in a page-like format, comprising:
(A) a computer processor;
(B) a computer memory electrically connected to said computer processor;
(C) a means for receiving a document into said computer memory;
(D) a document converter for converting said received document into a page view format;
(E) a page turner for animating a page object such that said page object appears to turn in a paper like manner so as to present a new page object; and
(F) a computer display for displaying said page object and said new page object.

2. A digital computer system as recited in claim 1, further comprising user controls in communication with said processor for controlling said display of said page object.

3. A digital computer system as recited in claim 2, wherein said user controls are selected from the group consisting of: a keyboard input device, a mouse input device, a touch screen input device, a track ball input device, a soft button displayable on said computer display, and a sound input device.

4. A digital computer system as recited in claim 1, wherein said means for receiving a document is selected from the group consisting of: a computer network data source, a CD-ROM device, a magnetic media storage device and an electronic memory storage device.

5. A digital computer system as recited in claim 1, wherein said document converter further comprises an HTML to XML format.

6. A digital computer system as recited in claim 1, wherein said page object further comprises a wireframe object having a bit-map fixed thereto.

7. A digital computer system as recited in claim 6, wherein said bit-map is a bit map of a section of said received document.

8. A digital computer system as recited in claim 1, wherein said page-turner further comprises a means for presenting a curled page in said computer display.

9. A digital computer system as recited in claim 1, further comprising a means for maintaining hyperlinks in said received document.

10. A digital computer system as recited in claim 1, further comprising a means for copying information from said page object to said computer memory.

11. A method of displaying computer information in a page-like format, comprising the steps of:
(A) loading a document from a document source;
(B) converting said loaded document to a page view format;
(C) displaying said converted document on a computer display device;
(D) enabling user controls of said displayed document; and
(E) turning pages of said displayed document under control of said enabled user controls.

12. A method of displaying computer information, as recited in claim 11, further comprising copying information from said displayed document to a computer memory device.

13. A method of displaying computer information, as recited in claim 11, wherein said loading a document further comprises:
(1) receiving a document from a digital computer source;
(2) identifying said document as a document for page viewing;
(3) parsing said document identified for page viewing; and
(4) storing said parsed document in a computer memory device.

14. A method of displaying computer information, as recited in claim 13, wherein said digital computer source is an Internet data source.

15. A method of displaying computer information, as recited in claim 11, wherein said turning pages of said displayed document further comprises:
(1) creating a wireframe object;
(2) creating a bit-map from said received document;
(3) fixing said bit-map to said wireframe object; and
(4) animating said wireframe object, having said bit-map fixed thereto such that said animation turns said wireframe object.

16. A method of displaying computer information, as recited in claim 15, wherein said creating a bit-map further comprises a bit map of information from said received document.

17. A process for creating a page-like display format for computer information, comprising:
(A) receiving a document from a source;
(B) performing a software function on said received document, wherein said software function converts said received document to an alternative format;
(C) performing an operating system function on said alternative format document, wherein said operating system function captures text and formats said captured text into a page view format; and
(D) executing a program to turn said page view formatted text.

18. A digital computer system, for displaying text, charts and images in a book-like display format, comprising:
(A) a computer processor having both random access memory and a mass storage device;
(B) a video display card, having a graphic processor, in electronic communication with said computer processor;
(C) an operating system, executed on said computer processor, said operating system being capable of managing a graphics user interface;
(D) a computer program being executed on said computer processor, wherein said computer program presents information in a display format which provides for the turning of pages of displayed information in a standard book-like format; and
(E) a high-resolution computer display device having sufficient display resolution to display a two-printed page graphic image in such a manner as headings and format are readable to a user, said high-resolution computer display in communication with said processor.

19. A digital computer system, for displaying text, charts and images in a book-like display format, as recited in claim 18, wherein said computer program further comprises: calculating the spatial information relationships between adjacent and back-to-back pages for the display in a standard book or magazine format as the pages are turned upon user command.

20. A digital computer system, for displaying text, charts and images in a book-like display format, as recited in claim 18, wherein said computer program operates to preserve the spatial relationship of one or more aspects of a document.
